(19) United States
(12) Patent Application Publication
(10) Pub. No.: US 2008/0187837 A1
(43) Pub. Date: Aug. 7, 2008

(54) ELECTRODE FOR ELECTROCHEMICAL DEVICE, ELECTROCHEMICAL DEVICE, AND METHOD FOR MANUFACTURING ELECTROCHEMICAL DEVICE

(75) Inventors: Yasuo Nakahara, Sumoto City (JP); Hiroshi Nonoue, Hirakata City (JP)

Correspondence Address: MOTS LAW, PLLC, 1001 PENNSYLVANIA AVE. N.W., SOUTH, SUITE 600, WASHINGTON, DC, 20004, US

(73) Assignee: SANYO ELECTRIC CO., LTD., Moriguchi City (JP)

(21) Appl. No.: 12/020,605

(22) Filed: Jan. 28, 2008

(30) Foreign Application Priority Data
Feb. 1, 2007 (JP) JP2007-023388

(51) Int. Cl. H01M 4/58; H01M 4/08

(52) U.S. Cl. 429/231.8; 427/113

(57) ABSTRACT

An electrochemical device includes an electrode formed using an electrode active material that includes: a carbon material having a crystal structure in which a plurality of graphite layers (31) are stacked; and a conductive polymer or conductive oligomer (32) which is intercalated between at least part of the graphite layers (31) and in which electron transfer takes place along with redox reaction.

### CROSS REFERENCE TO RELATED APPLICATION

This application is based upon and claims the benefit of priority from prior Japanese Patent Application No. 2007-023388, filed on Feb. 1, 2007; the entire contents of which are incorporated herein by reference.

### BACKGROUND OF THE INVENTION

1. Field of the Invention

The present invention relates to an electrode for an electrochemical device, including a conductive polymer or conductive oligomer, as well as to an electrochemical device and a method for manufacturing the electrochemical device.

2. Description of the Related Art

Electric double layer capacitors, which are small-size large-capacity capacitors, are used as back-up power supplies or secondary power supplies for mobile telephones and domestic electrical appliances. An electric double layer capacitor is formed by placing a separator between a pair of positive and negative electrodes and filling their surrounding space with an electrolyte. In general, the pair of positive and negative electrodes with the separator interposed therebetween (which is called “cell”) is placed in a housing case. The electrolyte is infused into this housing case. In recent years, as equipment on which an electric double layer capacitor is mounted is miniaturized and is improved in performance, there is increasing desire for larger-capacity electric double layer capacitors.

Energy E (joule) to be stored in a capacitor is calculated by using the following equation (1):

E=(½)CV² (1)

where C is the capacitance (farad) per cell of the capacitor, and V is the applied voltage (volt) to a cell. As shown in the equation (1), the energy E is proportional to the square of the value of the applied voltage V. Accordingly, to enhance the energy E, it is important to increase the voltage (withstand voltage) that can be applied between the positive and negative electrodes of the capacitor.

However, since the limit of the withstand voltage of an electric double layer capacitor is approximately 3 V, study has been conducted to develop an electrode in which the amount of electrical energy storage is increased by using a storage mechanism other than the electric double layer.

For example, an electrochemical capacitor device is known which uses an electrode including a current collector and an active material layer formed on the current collector. The active material layer is a mix of carbon material powder and organic compound powder from which electron transfer occurring along with redox reaction can be extracted as electron energy. The organic compound powder contains a n-conjugated n-doped conductive polymer. The electron transfer occurring along with the redox reaction of the organic compound powder is used for electrical energy storage, whereby an electrode is formed that has a larger storage capacity than an electrode using only the electric double layer.

### BRIEF SUMMARY OF THE INVENTION

A first aspect of the present invention is an electrochemical device including an electrode formed using an electrode active material that includes: a carbon material having a crystal structure in which a plurality of graphite layers are stacked; and any one of a conductive polymer and a conductive oligomer which is intercalated between at least part of the graphite layers and in which electron transfer takes place along with redox reaction.

In the first aspect, preferably, the carbon material is a graphite intercalation compound in which an alkali metal is intercalated between part of the graphite layers.

In the first aspect, the carbon material may include at least one member selected from the group consisting of graphite, graphitized carbon fiber, graphitized mesocarbon microbeads, graphitizable carbon materials, and non-graphitizable carbon materials.

In the first aspect, preferably, monomers of the conductive polymer or conductive oligomer include at least one member selected from the group consisting of acetylene, aniline, pyrrole, thiophene, pyridine, and ethylenedioxythiophene.

A second aspect of the present invention is an electrode for an electrochemical device, formed using an electrode active material that includes: a carbon material having a crystal structure in which a plurality of graphite layers are stacked; and any one of a conductive polymer and a conductive oligomer which is intercalated between at least part of the graphite layers and in which electron transfer takes place along with redox reaction.

A third aspect of the present invention is a method for manufacturing an electrochemical device, including: preparing a carbon material having a crystal structure in which a plurality of graphite layers are stacked; forming an electrode active material by intercalating any one of a conductive polymer and a conductive oligomer into between the graphite layers in the carbon material; and forming an electrode using the electrode active material, wherein the step of forming an electrode active material includes exposing the carbon material in a gas containing vapor of monomers of the conductive polymer or conductive oligomer.

In the third aspect, preferably, the step of forming an electrode active material further includes soaking the carbon material in a liquid in which monomers of the conductive polymer or conductive oligomer are dissolved, after the step of exposing the carbon material in the gas containing vapor of monomers of the conductive polymer or conductive oligomer.

### BRIEF DESCRIPTION OF THE DRAWINGS

FIG. 1A is a plane view showing an overall configuration of an electrochemical device according to an embodiment of the present invention.

FIG. 1B is a section view taken along the A-A line in FIG. 1A.

FIG. 2 is a schematic diagram to describe a crystal structure of an electrode active material according to the present embodiment.

FIG. 3 is a flowchart showing a method for manufacturing the electrochemical device shown in FIGS. 1A and 1B.

### DETAILED DESCRIPTION OF THE EMBODIMENTS

Hereinafter, embodiments of the present invention will be described with reference to the accompanying drawings. The same reference numerals are used throughout the drawings to refer to the same parts.

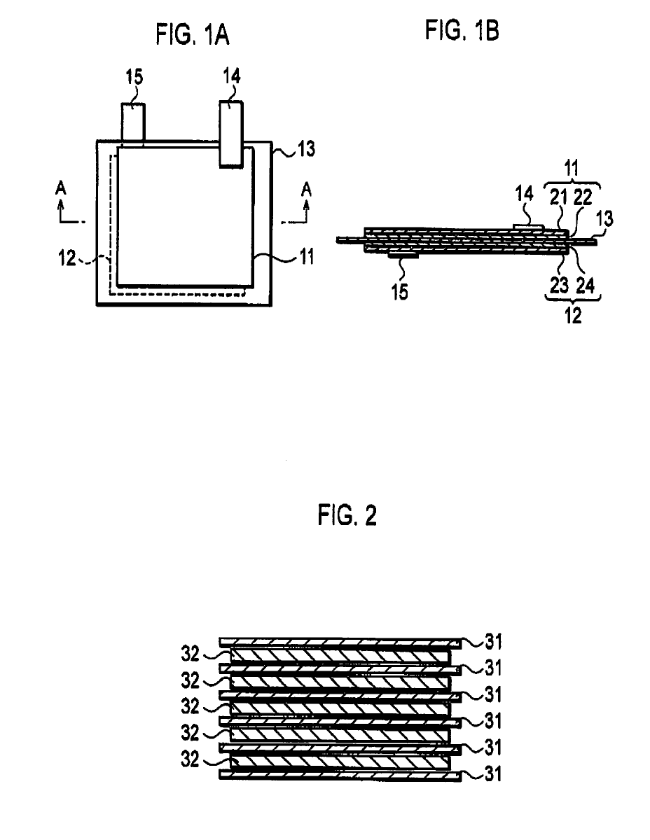

A configuration of an electrochemical device according to an embodiment of the present invention will be described with reference to FIGS. 1A and 1B. Referring to FIG. 1A, in this electrochemical device, a pair of positive and negative electrodes 11 and 12, facing each other with a separator 13 interposed therebetween, is housed in a sac-like aluminum laminated film case (not shown). An electrolyte is infused into the aluminum laminated film case. An aluminum tab lead 14 is connected to the positive electrode 11, and a nickel tab lead 15 is connected to the negative electrode 12. A potential difference is applied between the positive electrode 11 and the negative electrode 12 through the tab leads 14 and 15.

Referring to FIG. 1B, the positive electrode 11 is formed by stacking stainless steel foil 21 and an electrode active material 22. The negative electrode 12 is formed by stacking stainless steel foil 23 and an electrode active material 24. The positive electrode 11 and the negative electrode 12 are disposed in such a manner that they face each other with the electrode active materials 22 and 24 in contact with the front and back faces of the separator 13, respectively. The aluminum tab lead 14 is connected to the stainless steel foil 21, and the nickel tab lead 15 is connected to the stainless steel foil 23.

A crystal structure of the electrode active materials 22 and 24 will be described with reference to FIG. 2. The electrode active materials 22 and 24 both include a carbon material having a crystal structure in which a plurality of graphite layers 31 are stacked, and a conductive polymer or conductive oligomer 32 which is intercalated between at least part of the graphite layers 31 and in which electron transfer takes place along with redox reaction. The carbon material is a graphite intercalation compound (C₆Li) in which an alkali metal (e.g., lithium) is intercalated between part of the graphite layers 31. As an example of monomers of the conductive polymer or conductive oligomer 32, pyrrole is intercalated between the graphite layers in the graphite intercalation compound. That is, the monomers (pyrrole) are polymerized between the graphite layers (graphene sheets) 31, whereby a composite material is formed in which the conductive polymer or conductive oligomer and the graphite material are integrated. Thus, the degree to which conduction is lost by the influence of the degradation and fragmentation of the electrode active material is reduced, and the degradation of the electrode active material also can be decreased.

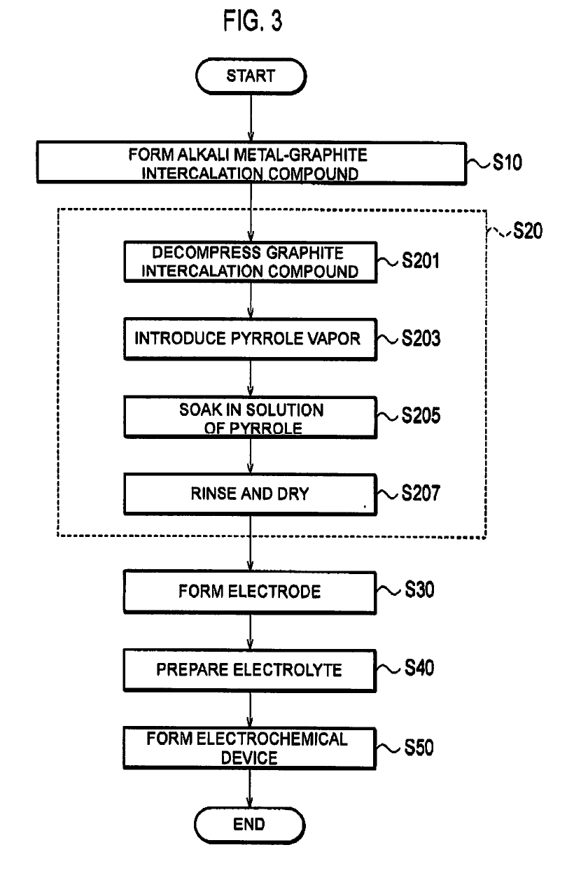

A method for manufacturing the electrochemical device shown in FIGS. 1A and 1B will be described with reference to FIG. 3.

a) First, in Step S10, natural graphite with a particle size of approximately 30 μm and lithium (Li), as an example of the alkali metal, are prepared. Next, the graphite intercalation compound (C₆Li) in which lithium is intercalated between part of the graphite layers is formed by using a two-bulb method. Incidentally, the two-bulb method is a method by which a material is intercalated into between graphite layers in such a manner that a graphite sample and the material to be intercalated into between the graphite layers are set at separate places in a reactor tube, and the to-be-intercalated material in a gaseous form is made to contact and react with the graphite by keeping the respective temperatures of the graphite and the to-be-intercalated material constant. Details of the two-bulb method are described in “Graphite intercalation compound,” Realize Company, 1990, pp. 7-11.

b) Inside an argon glove box, the graphite intercalation compound (C₆Li) is placed in a pressure-resistant hermetic container with a valve. In Step S201, the pressure inside the pressure-resistant hermetic container is reduced to 0.13 Pa or lower. Thereafter, in Step S203, pyrrole vapor corresponding to the vapor pressure of pyrrole at ambient temperature is introduced into the graphite intercalation compound (C₆Li). Then, the pressure-resistant hermetic container is placed back in the argon glove box again. In Step S205, the graphite intercalation compound (C₆Li), taken out of the pressure-resistant hermetic container, is soaked in propylene carbonate in which 0.1 ml/l of pyrrole and 0.1 ml/l of (C₂H₅)₄NBF₄ are dissolved. Thereafter, in Step S207, the graphite intercalation compound (C₆Li) is rinsed with pure propylene carbonate and then dried. Through Step S201 to Step S207, pyrrole, as an example of monomers of the conductive polymer or conductive oligomer, can be intercalated into between the graphite layers in the graphite intercalation compound (C₆Li) (Step S20). In other words, a composite material in which the conductive polymer or conductive oligomer and the graphite material are integrated can be formed by polymerizing the monomers between the graphite layers (graphene sheets). Thereby, the degree to which conduction is lost by the influence of the degradation and fragmentation of the electrode active material is reduced. In addition, the degradation of the electrode active material also can be decreased.

c) In Step S30, the positive and negative electrodes are formed which include, as the electrode active material, the graphite intercalation compound with pyrrole intercalated between the graphite layers. Specifically, N-methylpyrrolidone is added into a mix of 90 weight percent of the graphite intercalation compound and 10 weight percent polyvinylidene fluoride, in an amount three times the weight of the mix. Thereafter, the resulting mix is blended enough, thus obtaining a slurry. After this slurry is applied onto stainless steel (SUS316L) foil with a thickness of 30 μm, the slurry is dried to obtain a mixture. The stainless steel foil with this mixture applied thereon is cut into 2-cm square pieces, two of which make the positive electrode 11 and the negative electrode 12. The aluminum tab lead 14 is attached to a surface of the stainless steel foil 21 of the positive electrode 11 on which the mixture 22 is not applied, and the nickel tab lead 15 is attached to a surface of the stainless steel foil 23 of the negative electrode 12 on which the mixture 24 is not applied, whereby current-carrying terminals are formed.

d) In Step S40, the electrolyte is prepared. specifically, propylene carbonate is used as a solvent, in which a solute, (C₂H₅)₄NBF₄, is dissolved at a concentration of 1 mol/l, thus preparing the electrolyte.

e) In Step S50, the faces of the positive electrode 11 and the negative electrode 12 on which the mixture is applied are faced to each other, with a 2.5-cm square piece of polypropylene nonwoven fabric (separator) interposed therebetween. Fixed in this state, the positive electrode 11 and the negative electrode 12 are placed in a sac-like (7 cm long 5 cm wide) aluminum laminated film case. Subsequently, 0.5 ml of the electrolyte is infused into the aluminum laminated film case, and then an opening portion of the case is sealed with a heat seal. Through the above-described steps, the electrochemical device shown in FIGS. 1A and 1B is completed.

### Experimental Examples

On the electrochemical device according to the above-described embodiment of the present invention and also electrochemical devices according to undermentioned first and second comparative examples, the present inventors carried out charging and discharging repeatedly and evaluated the discharge capacity and internal resistance thereafter.

As to the electrochemical device according to the first comparative example, the steps for intercalating pyrrole into the graphite intercalation compound (C₆Li), which are Step S20 in FIG. 3, were not performed. Specifically, electrodes were formed using a slurry which was obtained by adding N-methylpyrrolidone into a mix of 45 weight percent of the graphite intercalation compound (C₆Li), 45 weight percent polypyrrole, and 10 weight percent polyvinylidene fluoride, in an amount three times the weight of the mix. The electrochemical device was formed through a procedure that is, in the other points, the same as in the above-described embodiment.

As for the electrochemical device according to the second comparative example, the steps for intercalating pyrrole into the graphite intercalation compound (C₆Li), which are Step S20 in FIG. 3, were not performed. Specifically, electrodes were formed using a slurry which was obtained by adding N-methylpyrrolidone into a mix of 90 weight percent of the graphite intercalation compound (C₆Li) and 10 weight percent polyvinylidene fluoride, in an amount three times the weight of the mix. The electrochemical device was formed through a procedure that is, in the other points, the same as in the above-described embodiment.

Charging and discharging were repeatedly carried out on each of the electrochemical devices according to the above-described embodiment, first comparative example, and second comparative example, under conditions as described below. First, charging was carried out at a constant voltage of 2.5 V for one hour. In this event, current was restricted to 2 mA or below. Then, discharging was carried out at a constant current of 2 mA until the voltage became 1.5 V. Table 1 shows the discharge capacities and internal resistances after the above-described charging and discharging were carried out five cycles, and those after one thousand cycles. Note that the values in Table 1 are normalized values in the case of assuming that the discharge capacity and internal resistance of the electrochemical device according to the above-described embodiment after five cycles are both 100.

TABLE 1

| | After 5 cycles | | After 1000 cycles | |
|---|---|---|---|---|
| | Discharge | Internal | Discharge | Internal |
| | capacity | resistance | capacity | resistance |
| Embodiment of the | 100 | 100 | 90 | 130 |
| present invention | | | | |
| First comparative | 110 | 120 | 10 | 1000 |
| example | | | | |
| Second comparative | 5 | 50 | 3 | 70 |
| example | | | | |

In the above-described embodiment of the present invention, by carrying out Step S20, great part of the pyrrole supplied between the graphite layers is retained between the graphite layers as a polymer or an oligomer of pyrrole, and this fact contributes to electrical energy storage. On the other hand, in the first comparative example, Step S20 was not carried out, but instead a slurry was formed simply by mixing the graphite intercalation compound (C₆Li) and polypyrrole. Therefore, a polymer or an oligomer of pyrrole was locally over-oxidized and over-reduced along with charging and discharging cycles and thus came not to contribute to electrical energy storage. Hence, according to the above-described embodiment of the present invention, in comparison with the first comparative example, it is possible to retard the degradation of the discharge capacity and an increase in the internal resistance after charging and discharging cycles.

### Other Embodiments

As described above, the present invention has been discussed through one embodiment. However, it should not be understood that the description and drawings constituting part of this disclosure are intended to restrict the present invention. From this disclosure, various alternative embodiments, examples, and operational techniques will become apparent to those skilled in the art.

The graphite intercalation compound (C₆Li) taken from the positive and negative electrodes according to the above-described embodiment of the present invention was analyzed by using an XRD. The result was that no compound of a pyrrole monomer and carbon originated from the graphite intercalation compound (C₆Li) was observed. As can be understood from this fact, although pyrrole was used as monomers intercalated into the graphite intercalation compound (C₆Li) in the above-described embodiment of the present invention, the monomers are not limited to pyrrole. At least one member selected from the group consisting of acetylene, aniline, pyrrole, thiophene, pyridine, and ethylenedioxythiophene can be intercalated into the graphite intercalation compound (C₆Li) as monomers of the conductive polymer or conductive oligomer.

Moreover, by way of example, description has been given of the graphite intercalation compound (C₆Li) in which lithium, as an alkali metal, is intercalated between part of the graphite layers. However, the alkali metal is not limited to lithium. It is also possible to use a graphite intercalation compound (C₈K or the like) in which another alkali metal such as potassium (K) is intercalated between part of the graphite layers. Further, the graphite intercalation compound is not limited to an alkali metal-graphite intercalation compound in which an alkali metal is intercalated between the graphite layers, but it is possible to use any carbon material having a graphite layered structure into which monomers can be intercalated: for example, at least one member selected from the group consisting of graphite, graphitized carbon fiber, graphitized mesocarbon microbeads, graphitizable carbon materials, and non-graphitizable carbon materials. The use of such a carbon material makes it easy to intercalate the conductive polymer or conductive oligomer into between the graphite layers.

As described above, it should be understood that the present invention incorporates various embodiments and the like which are not described herein. Accordingly, the present invention should be limited only by matters defining an invention in the claims which are appropriate from the view point of the description.

### (Operation and Effects)

As described hereinabove, according to the embodiments of the present invention, the following operation and effects can be achieved.

An electrochemical device according to any of the embodiments includes an electrode formed using an electrode active material that includes: a carbon material having a crystal structure in which a plurality of graphite layers are stacked; and a conductive polymer or conductive oligomer which is intercalated between at least part of the graphite layers and in which electron transfer takes place along with redox reaction. For the fact that a conductive polymer or conductive oligomer is intercalated between the graphite layers in the carbon material, the degradation of the electrode occurring along with the long-term use of the electrochemical device can be decreased.

The carbon material is a graphite intercalation compound in which an alkali metal is intercalated between part of the graphite layers. The fact that the carbon material is a graphite intercalation compound in which an alkali metal is intercalated between part of the graphite layers, makes it easier to intercalate the conductive polymer or conductive oligomer into between the graphite layers.

The carbon material may include at least one member selected from the group consisting of graphite, graphitized carbon fiber, graphitized mesocarbon microbeads, graphitizable carbon materials, and non-graphitizable carbon materials. For this fact, it is possible to intercalate the conductive polymer or conductive oligomer into between the graphite layers in the carbon material.

Monomers of the conductive polymer or conductive oligomer include at least one member selected from the group consisting of acetylene, aniline, pyrrole, thiophene, pyridine, and ethylenedioxythiophene. For this fact, it is possible to intercalate the conductive polymer or conductive oligomer that contributes to electrical energy storage, into between the graphite layers.

A method for manufacturing an electrochemical device according to any of the embodiments includes; preparing a carbon material having a crystal structure in which a plurality of graphite layers are stacked; forming an electrode active material by intercalating a conductive polymer or conductive oligomer into between the graphite layers in the carbon material; and forming an electrode using the electrode active material. The step of forming an electrode active material at least includes exposing the carbon material in a gas containing vapor of monomers of the conductive polymer or conductive oligomer.

By exposing the carbon material in a gas containing vapor of monomers of the conductive polymer or conductive oligomer, it is possible to intercalate the conductive polymer or conductive oligomer into between the graphite layers. Accordingly, the degradation of the electrode occurring along with the long-term use of the electrochemical device can be decreased.

The step of forming an electrode active material further includes soaking the carbon material in a liquid in which monomers of the conductive polymer or conductive oligomer are dissolved, after the step of exposing the carbon material in a gas containing vapor of monomers of the conductive polymer or conductive oligomer. With this step, it is possible to intercalate more of the conductive polymer or conductive oligomer into between the graphite layers.

What is claimed is:

1. An electrochemical device, comprising an electrode formed using an electrode active material that includes:
a carbon material having a crystal structure in which a plurality of graphite layers are stacked; and
any one of a conductive polymer and a conductive oligomer which is intercalated between at least part of the graphite layers and in which electron transfer takes place along with redox reaction.

2. The electrochemical device according to claim 1, wherein the carbon material is a graphite intercalation compound in which an alkali metal is intercalated between part of the graphite layers.

3. The electrochemical device according to claim 1, wherein the carbon material includes at least one member selected from the group consisting of graphite, graphitized carbon fiber, graphitized mesocarbon microbeads, graphitizable carbon materials, and non-graphitizable carbon materials.

4. The electrochemical device according to claim 1, wherein monomers of the conductive polymer or conductive oligomer include at least one member selected from the group consisting of acetylene, aniline, pyrrole, thiophene, pyridine, and ethylenedioxythiophene.

5. An electrode for an electrochemical device, formed using an electrode active material that includes:
a carbon material having a crystal structure in which a plurality of graphite layers are stacked; and
any one of a conductive polymer and a conductive oligomer which is intercalated between the graphite layers and in which electron transfer takes place along with redox reaction.

6. A method for manufacturing an electrochemical device, comprising:
preparing a carbon material having a crystal structure in which a plurality of graphite layers are stacked;
forming an electrode active material by intercalating any one of a conductive polymer and a conductive oligomer into between the graphite layers in the carbon material; and
forming an electrode using the electrode active material,
wherein the step of forming an electrode active material at least includes exposing the carbon material in a gas containing vapor of monomers of the conductive polymer or conductive oligomer.

7. The method for manufacturing an electrochemical device according to claim 6, wherein the step of forming an electrode active material further includes soaking the carbon material in a liquid in which monomers of the conductive polymer or conductive oligomer are dissolved, after the step of exposing the carbon material in the gas containing vapor of monomers of the conductive polymer or conductive oligomer.
